(19) United States
(12) Patent Application Publication
(10) Pub. No.: US 2003/0016735 A1
(43) Pub. Date: Jan. 23, 2003

(54) Communication system for two-way exchange of information

(76) Inventors: Peter J. Edmonson, Hamilton (CA); Colin K. Campbell, Ancaster (CA)

Correspondence Address: GOWLING LAFLEUR HENDERSON LLP, P.O. 1045 LCD1, Suite 560, 120 King Street West, Hamilton, ON, L8N 3R4, CA

(21) Appl. No.: 09/909,969

(22) Filed: Jul. 23, 2001

(51) Int. Cl. H04L 5/16; H04B 1/38

(52) U.S. Cl. 375/219

(57) ABSTRACT

A communication system for two-way exchange of information using a binary coded waveform has a base unit operable to transmit and receive electromagnetic radiation waveforms modulated by binary coded voice or data message signals, and a hybrid unit remote from the base unit and operable to receive and transmit binary coded electromagnetic radiation waveforms from and to the base unit.

The hybrid unit has a first surface acoustic wave device with an input to receive a binary coded electromagnetic radiation waveform from the base unit and cause a corresponding binary coded surface acoustic wave to travel from the input to an output thereof and be reflected back to the input.

A first transducer is connected to the output to receive further information from a source thereof and modify the reflected surface acoustic waveform, whereby the reflected surface acoustic waveform incorporates such further information and becomes a modified reflected surface acoustic waveform which travels to the input and then travels as a modified binary coded electromagnetic waveform to the base unit.

This invention relates to communication systems for two-way exchange of information using a binary coded waveform. The information may for example be data and/or voice message signals.

### BACKGROUND OF INVENTION

Although many different types of communication systems for two-way exchange of information are of course known, there still exists a need for such a communication system, especially a short-range system, where low power consumption is a major concern.

It is therefore an object of the invention to provide a communication system which satisfies this requirement.

### SUMMARY OF INVENTION

According to the invention, a communication system for two-way exchange of information uses a binary coded waveform and has a base unit operable to transmit and receive electromagnetic radiation waveforms modulated by binary coded voice or data message signals. The system also includes a hybrid unit remote from the base unit and operable to receive and transmit binary coded electromagnetic radiation waveforms from and to the base unit.

The hybrid unit has a first surface acoustic wave (SAW) device with an inlet to receive a binary coded electromagnetic radiation waveform from the base unit and cause a corresponding binary coded surface acoustic wave to travel from the input to an output thereof and be reflected back to the input. A first transducer is connected to the output to receive further information from a source thereof and appropriately modify the reflected surface acoustic waveform whereby the reflected surface acoustic waveform incorporates the further information and becomes a modified reflected surface acoustic waveform which travels to the input and is transmitted as a modified binary coded electromagnetic waveform to the base unit.

The hybrid unit may also have a second acoustic wave device with an input to receive said binary coded electromagnetic radiation waveform from the base unit and cause a corresponding binary coded surface acoustic wave to travel from the input to an output thereof, the output of the second surface acoustic wave device comprising a filter arrangement to decode the binary coded electromagnetic radiation waveform, and a second transducer which is appropriately actuated by the decoded output.

The first transducer may be a microphone, and the second transducer may be a loud speaker.

### BRIEF DESCRIPTION OF THE DRAWINGS

Embodiments of the invention will now be described, by way of example only, with reference to the accompanying drawings of which:

FIG. 1 is a schematic circuit diagram of a communication system in accordance with one embodiment of the invention and showing the base unit and the hybrid SAW/transducer unit,

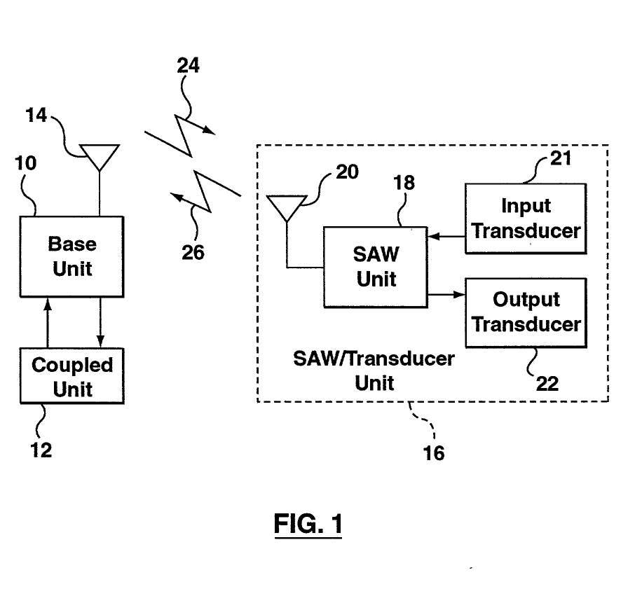

FIG. 2 is a more detailed view of the hybrid SAW/transducer unit shown in FIG. 1,

FIG. 3 is similar to FIG. 2 but shows a hybrid SAW/transducer unit with specific input and output transducers, i.e. a microphone and a loud speaker,

FIG. 4 is a conceptual drawing showing the waveforms at various points in the communication system,

FIG. 5 is a graph showing a mathematical simulation of an auto-correlation function which results from a selected coded waveform passing through an appropriate matched SAW filter,

FIG. 6 is a similar graph but showing a cross-correlation function which results from a selected coded waveform passing through an inappropriate matched SAW filter,

FIG. 7 is similar to FIG. 2 but shows a modified embodiment, and

FIG. 8 is a graph illustrating the frequency response of SAW filters in the modified embodiment shown in FIG. 7.

### DESCRIPTION OF PREFERRED EMBODIMENTS

Referring to the drawings, a communication system has a base unit 10 with a coupled unit 12 interfaced therewith for exchanging information therebetween, the base unit 10 being provided with an antenna 14. The base unit 10 is capable of communicating with a remote addressable SAW/transducer (hybrid) unit 16 which includes a SAW unit 18 with an antenna 20. The SAW unit 18 is connected to an input transducer 21 and an output transducer 22. The base unit 10 may for example be a cell phone, with the hybrid unit 16 being incorporated in a remote head set therefor.

The base unit 10 initiates a combined data/interrogation coded waveform 24 which is propagated by antenna 14 within an approximately one meter radius thereof. The waveform 24 is received by the antenna 20 of the SAW/transducer unit 16 and is passed to the SAW unit 18 where it excites a set of coded acoustic waves which propagates to a set of reflectors attached to the input transducer 21. The impedance of the input transducer 21 will affect the characteristics of the reflected acoustic waves from the reflectors in a manner which depends on the information present at the input transducer 21.

The reflected acoustic wave is propagated within the SAW unit 18 where an electromagnetic waveform is excited and transmitted from the antenna 20 as waveform 26 to antenna 14 of base unit 10. The data carried by the return electromagnetic waveform is decoded by the base unit 10 and transferred to the coupled unit 12.

When data is being delivered to the SAW/transducer unit 16, another set of acoustic waves is propagated within the SAW unit 18 to a set of matched filters whose output is decoded and caused to appropriately activate the output transducer 22.

Thus, the interrogation waveform destined for the input transducer 21 also contains information to be delivered to the output transducer 22.

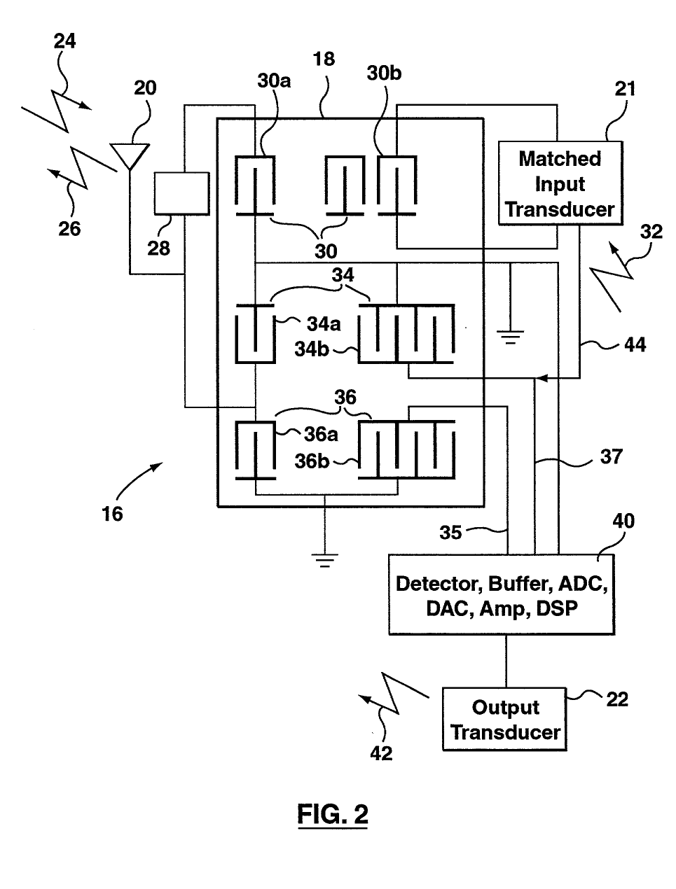

The SAW/transducer unit 16 is shown in somewhat more detail in FIG. 2. The coded interrogation waveform 24 received by antenna 20 is controlled by an RF switch 28 and passed to a port 30a of a SAW assembly 30 to cause a coded interrogation acoustic waveform to propagate towards a reflector acting as port 30b of the SAW assembly 30. Port 30b is connected to the input transducer 21 which received input from a source indicated as waveform 32. There is a controlling relationship between the impedance of the input transducer 21 and the modification thereof by the acoustic reflective properties of the SAW port 30b. The change in reflective properties will modify the reflected acoustic coded waveform being sent back towards port 30a in a manner characteristic of the change of impedance of the input transducer 21. The purpose of the RF switch 28 is to permit multiple addressable SAW/transducer units 16 to be wirelessly controlled by the same base unit 10.

The same coded waveform 24 which is received by antenna 20 is also simultaneously conveyed to a port 34a of a SAW assembly 34 and to a port 36a of a further SAW assembly 36, such that a coded acoustic waveform is propagated to output ports 34b,36b. The output ports 34b, 36b are coded matched filters which are capable of producing convolved output signals which are passed to a detector circuit 40 which can detect the signals as a binary “0” or “1” depending on the input coded waveform. The output from detector circuit 40 passes to the output transducer 22 which propagates an output signal 42.

For periods of lengthy inactivity of the input transducer 21, an ultra low-power “sleep mode” can be activated so that the base unit 10 does not continue to interrogate and consume power when no information is being transferred. This would stop all interrogation waveforms from the base unit 10 to the SAW/transducer unit 16. RF communication links, i.e. waveforms 24, 26, between the base unit 10 and the SAW/transducer unit 16 would be resumed, when input 32 is received by the input transducer 21, by having the input transducer 21 send a suitable notification signal through line 44 to port 34b of coded SAW assembly 34. This would result in a coded acoustic waveform being sent to port 34a and then via antennas 20, 14 to the base unit 10.

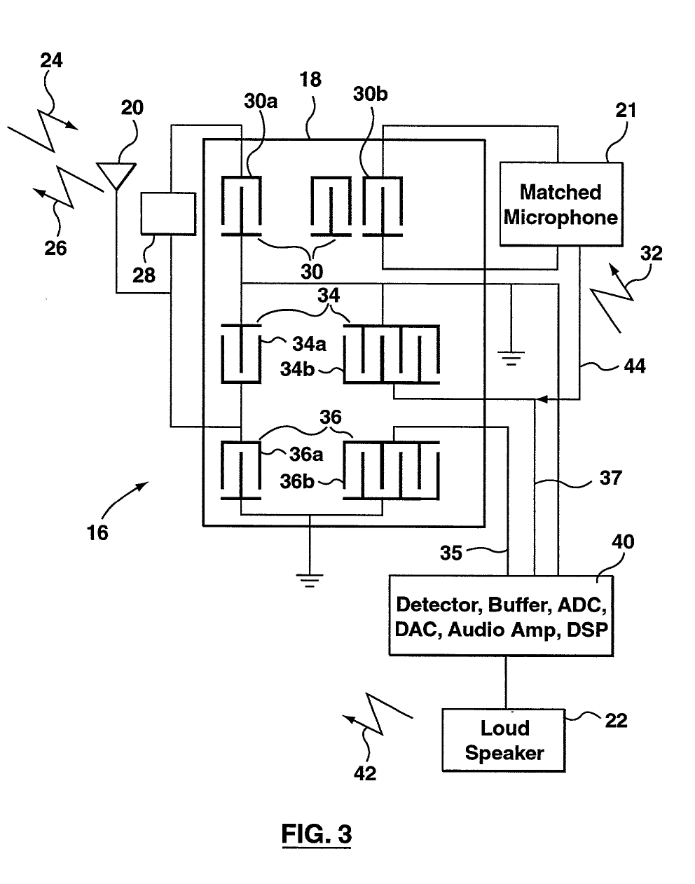

FIG. 3 shows a SAW/transducer unit 16 intended for use as a wireless ear piece. The input transducer 21 is a microphone and the output transducer 22 is a small speaker which is integrated into the hybrid structure and placed in close proximity to the ear.

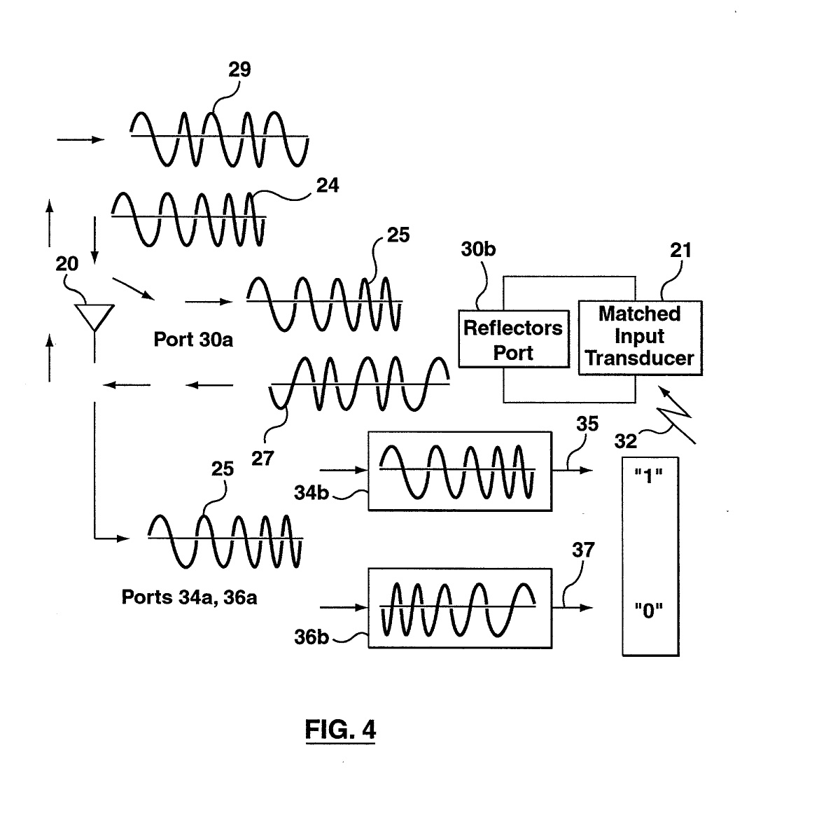

The event sequence for a binary coded waveform acting both as an interrogating stimulus for the input transducer 21 and also containing information to be delivered to the output transducer 22 is shown in FIG. 4,

A coded RF waveform 24 is sent from the base unit 10 to the SAW/transducer unit 18 via antennas 14 and 20. The waveform 24 shown in FIG. 4 is represented in a manner to indicate that the signal is not a continuous RF waveform but is a coded signal identical in frequency and phase parameters to one of the matched filters at ports 34b and 36b in the SAW assembly 18.

The coded waveform 24 thus reaches port 30a of the first SAW assembly 30, and a resultant identically coded waveform 25 is consequently propagated towards port 30b which, as previously mentioned, comprises a set of reflectors attached to matched input transducer 21. As the input source 32 changes, the characteristic impedance of the input transducer 21 also changes to modify the reflective properties of the reflectors at port 32b such that a modified acoustic waveform 27 is propagated back to port 30a. At port 30a, the modified acoustic waveform 27 is converted to an electromagnetic wave retaining the modified frequency and phase characteristics which is propagated from antenna 20 as a modified waveform 29 back to the antenna 14 of the base unit 10. The modified waveform 29 is deciphered by the base unit 10 to extract the information inputted to the input transducer 21 by the waveform signal 32.

To deliver information to the output transducer 22, the waveform 25 sent to the SAW assembly 30 is also sent to ports 34a and 36a of SAW assemblies 34, 36 so that two identically coded acoustic waveforms 25 are propagated to the two matched filters at ports 34b, 36b respectively. Two different impulse responses will occur at the matched filter outputs 35, 37 depending on the correlation factor of the coded waveform and the matched filters. The output 35, 37 are sent to the detector circuit 40 (FIGS. 2 and 3) for further processing to determine their values of “0” and “1”. For example, if output 35 is a “1”, then output 37 must be a “0”, or vice versa, in normal operation.

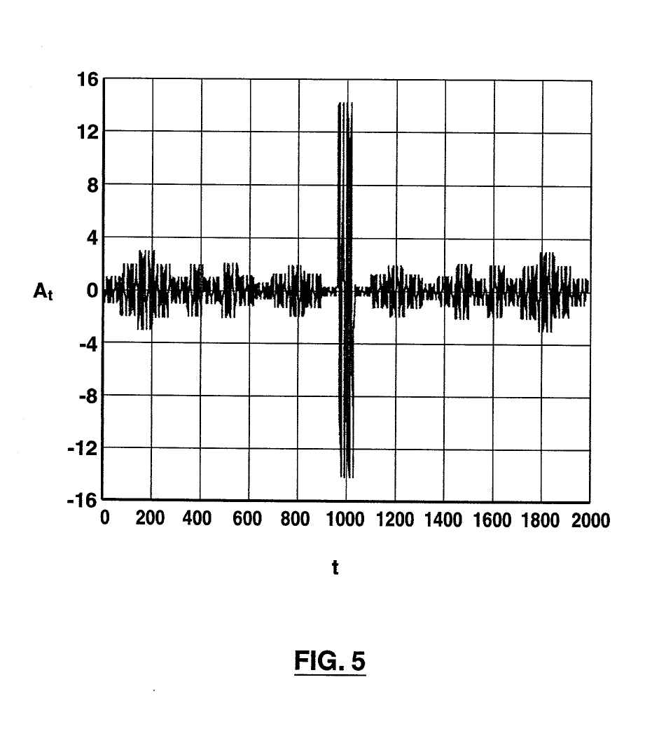

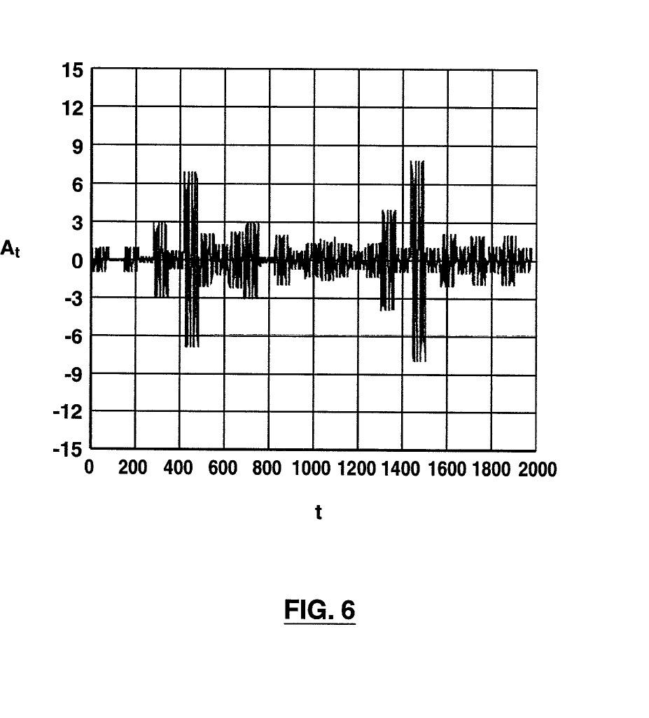

FIG. 5 is a graph showing the auto correlation of output 35, and FIG. 6 is a graph showing the simultaneous cross correlation of output 37. By way of example, two 15 chip Gold codes may be used as the match filters with one of the codes being used to modulate the coded waveform 24. The detector circuit 40 may be constructed to take advantage of the two distinct waveforms shown in FIGS. 5 and 6 in determining the correct output level to the output transducer 22.

To avoid erroneous detection of the reflected wave 27 which will re-enter the two matched filters 34b and 36b, a gating/timing circuit may be embedded into the detector 40 to effectively shut down any detection for a time period which equates to the transit time of the reflective waveform through to the matched filter. This does not impede the reflective wave 27 being sent back to the base unit 10 via the antenna 20.

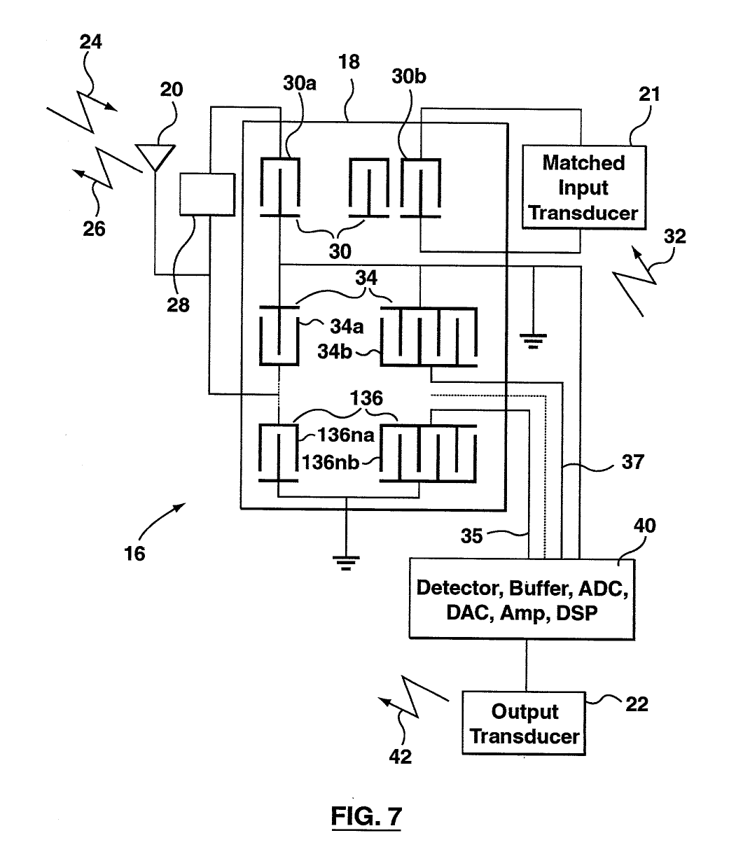

FIG. 7 is similar to FIG. 2 but shows a modified embodiment. Where possible, the same reference numerals will be used to indicate similar components. In FIG. 7, the other set of acoustic waves is propagated within SAW unit 18 to one or more band pass filters connected as a filter bank whose output is decoded and caused to appropriately actuate the output transducer 32.

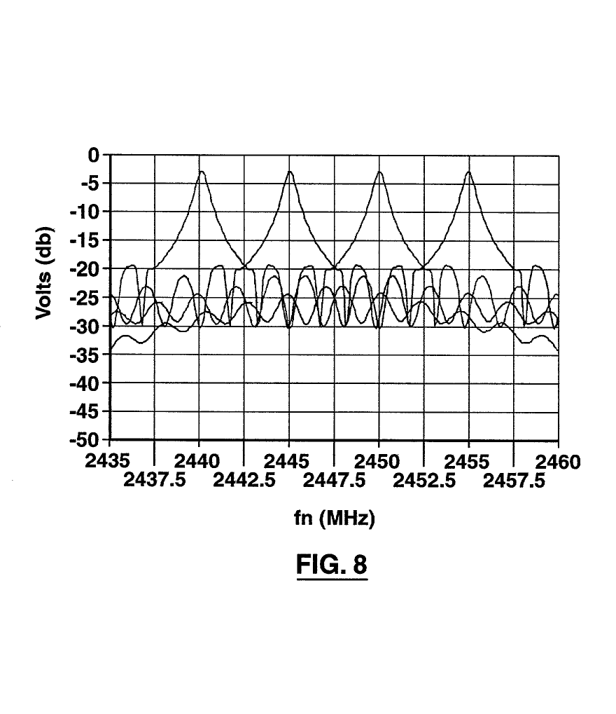

In this case, the same coded wave form 24 which is received by antenna 20 (or a similar binary coded waveform which may be continuous) is also simultaneously conveyed to port 34a of SAW assembly 34 and to “n” ports 136na of a further SAW assembly 136 where “n” represents a number of frequency channels to be utilized. The coded wave form is propagated to corresponding output ports 34b and 136nb which are part of a filter bank which separates out discrete channels which are passed to detector circuit 40. FIG. 8 illustrates the frequency response of “n” filters. It will be noted that, with this modified embodiment, the sleep mode mentioned as an option for the previously described embodiment would not be required.

From the above description of preferred embodiments, a person skilled in the art will appreciate that the present invention enables a two-way communication system to be provided which not only has low power consumption but also has relatively low cost and simplicity. The scope of the invention is defined in the appended claims.

1. A communication system for two-way exchange of information using a binary coded waveform, said system having:
a base unit operable to transmit and receive electromagnetic radiation waveforms modulated by binary coded voice or data message signals,
a hybrid unit remote from the base unit and operable to receive and transmit binary coded electromagnetic radiation waveforms from and to the base unit,
said hybrid unit having a first surface acoustic wave device with an input to receive a binary coded electromagnetic radiation waveform from the base unit and cause a corresponding binary coded surface acoustic wave to travel from the input to an output thereof and be reflected back to the input, and
a first transducer connected to said output to receive further information from a source thereof and modify said reflected surface acoustic waveform whereby said reflected surface acoustic waveform incorporates such further information and becomes a modified reflected surface acoustic waveform which travels to said input and then travels as a modified binary coded electromagnetic waveform to the base unit.

2. A communication system according to claim 1 wherein the first transducer is a microphone.

3. A communication system according to claim 1 wherein the hybrid unit also has a second surface acoustic wave device with an input to receive said binary coded electromagnetic radiation waveform from the base unit and cause a corresponding binary coded surface acoustic wave to travel from the input to an output thereof, the output of the second surface acoustic wave device comprising a filter arrangement to decode the binary coded electromagnetic radiation waveform, and a second transducer which is appropriately actuated by the decoded output.

4. A communication system according to claim 3 wherein the second transducer is a loud speaker.

5. A communication system according to claim 1 wherein the hybrid unit also has a second surface acoustic wave device with an input to receive said binary coded electromagnetic radiation waveform from the base unit and cause a corresponding binary coded surface acoustic wave to travel from the input to an output thereof, the output of the second surface acoustic wave device comprising a filter arrangement to decode the binary coded electromagnetic radiation waveform, and a second transducer which is appropriately actuated by the decoded output, the first transducer being a microphone and the second transducer being a loud speaker.

6 A hybrid unit for a communication system and operable to receive and transmit electromagnetic radiation waveforms modulated by binary coded voice or data message signals from and to a base unit, said hybrid unit having a first surface acoustic wave device with an input to receive a binary coded electromagnetic radiation waveform from the base unit and cause a corresponding binary coded surface acoustic wave to travel from the input to an output thereof and be reflected back to the input, and
a first transducer connected to said output to receive further information from a source thereof and modify said reflected surface acoustic waveform whereby said reflected surface acoustic waveform incorporates such further information and becomes a modified reflected surface acoustic waveform which travels to said input and then travels as a modified binary coded electromagnetic waveform to the base unit.

7. A hybrid unit according to claim 6 wherein the first transducer is a microphone.

8. A hybrid unit according to claim 6 also having a second surface acoustic wave device with an input to receive said binary coded electromagnetic radiation waveform from the base unit and cause a corresponding binary coded surface acoustic wave to travel from the input to an output thereof, the output of the second surface acoustic wave device comprising a filter arrangement to decode the binary coded electromagnetic radiation waveform, and a second transducer which is appropriately actuated by the decoded output.

9. A hybrid unit according to claim 8 wherein the second transducer is a loud speaker.

10. A hybrid unit according to claim 6 wherein the hybrid unit also has a second surface acoustic wave device with an input to receive said binary coded electromagnetic radiation waveform from the base unit and cause a corresponding binary coded surface acoustic wave to travel-from the input to an output thereof, the output of the second surface acoustic wave device comprising a filter arrangement to decode the binary coded electromagnetic radiation waveform, and a second transducer which is appropriately actuated by the decoded output, the first transducer being a microphone and the second transducer being a loud speaker.
